(19) United States
(12) Patent Application Publication
(10) Pub. No.: US 2022/0091246 A1
(43) Pub. Date: Mar. 24, 2022

(54) METHOD AND MONITORING DEVICE

(71) Applicant: KSPG Innovations GmbH, Neckarsulm (DE)

(72) Inventors: Harald BLOMERIUS, Koln (DE); Robert CLAESER, Dusseldorf (DE); Björn SONDERMANN, Aachen (DE); Peter SEGGEWIß, Willich (DE); Karsten FENT, Pulheim (DE)

(21) Appl. No.: 17/448,023

(22) Filed: Sep. 17, 2021

(30) Foreign Application Priority Data
Sep. 18, 2020 (DE) 10 2020 124 444.4

(51) Int. Cl. G01S 13/04; H01Q 3/34; G01S 13/931

(52) U.S. Cl. CPC G01S 13/04; G01S 2013/9315; G01S 13/931; H01Q 3/34

(57) ABSTRACT

A method for monitoring an interior and/or an exterior of a motor vehicle, comprising the following steps: a) Emitting electromagnetic radiation into the interior and/or into the exterior, b) Reflecting the electromagnetic radiation at an object arranged in the interior and/or in the exterior, c) receiving electromagnetic radiation reflected from the object, and d) compressed sensing a signal of the reflected electromagnetic radiation to derive therefrom an information about a state of the object.

### FIELD

The present invention relates to a method for monitoring an interior and/or an exterior of a motor vehicle, and to a monitoring device for monitoring the interior and/or the exterior of the motor vehicle.

### BACKGROUND

People monitoring in or next to a motor vehicle is becoming increasingly important. For example, systems for fatigue detection have been used in motor vehicles for some time. Furthermore, motor vehicles have systems for seat occupancy detection or blind spot assistants. Each of these systems is implemented with its own independent components, such as cameras for fatigue detection, mats for seat occupancy detection, vapor-deposited wires for rear window heating, cables for power supply, ultrasound for a blind spot assistant or the like.

When cameras are used to capture the interior scene in a motor vehicle, high computing power or expensive hardware, such as time-of-flight (TOF) cameras and lenses, is required. Radar detection requires the additional installation of a radar antenna inside the motor vehicle. Measuring the pulse of a vehicle occupant using radar is also susceptible to interference from vibrations in the vehicle and loud music that generates periodic vibrations.

Separate systems are thus required for heating the rear window, as well as individual systems in each case for providing communication and interior monitoring, as well as sensor technology in the direction of the vehicle's rear seat. Thus, many different systems and sensors are required. It is therefore desirable to provide a system that performs as many of the above tasks as possible while requiring few or no additional components.

### SUMMARY

Against this background, one object of the present invention is to provide an improved method for monitoring an interior and/or an exterior of a motor vehicle.

Accordingly, a method for monitoring an interior and/or an exterior of a motor vehicle is provided. The method comprises the following steps: a) emitting electromagnetic radiation into the interior and/or into the exterior, b) reflecting the electromagnetic radiation at an object arranged in the interior and/or in the exterior, c) receiving electromagnetic radiation reflected from the object, and d) compressed sensing a signal of the reflected electromagnetic radiation to derive therefrom an information about a state of the object.

By compressed sensing the signal of the reflected electromagnetic radiation, the amount of data can be kept small. Furthermore, even smallest amplitudes and weak signals can be evaluated. Due to the application of compressed sensing, an already existing radiation source can thus be used to emit the electromagnetic radiation.

In particular, the motor vehicle comprises a body that encloses the interior. The exterior is provided outside the body. That is, the body separates the interior from the exterior. For example, the interior can be accessible from the exterior via doors. For example, the method is suitable for monitoring the exterior in the area of the doors. The electromagnetic radiation is preferably emitted by a component of the motor vehicle which is provided anyway. This component is a radiation source. This means that no separate radiation source needs to be provided to carry out the method.

The radiation source can, for example, be an existing WLAN hotspot (Wireless Local Area Network, WLAN) of the motor vehicle. The radiation source can be an antenna of any design. For example, the radiation source may be an UWB antenna (Ultra-Wideband, UWB). The object may be, for example, a vehicle occupant or an animal. However, the object may also be inanimate. For example, the object may be a bag, a smartphone, or the like. The electromagnetic radiation is at least partially reflected and partially absorbed by the object. The reflected electromagnetic radiation is preferably received by a radiation receiver in the form of an antenna.

In the present context, “compressed sensing” means a method for the acquisition and reconstruction of sparse signals or information sources. Due to their redundancy, these signals can be compressed without significant loss of information. This is used in the sampling of the signals to significantly reduce the sampling rate compared to other methods. As previously mentioned, this allows the amount of data to be kept small. Furthermore, even very weak signals and smallest amplitudes can be evaluated.

The “state” of the object can be understood as its position in the interior and/or in the exterior. In this case, the “information” is to be understood as whether and where the object is arranged in the interior and/or in the exterior. However, the state can also be, for example, a vital function of an object in the form of a living being. In this case, the information is, for example, the heart rate or the breathing rate of the living being. Through this, the method can also be used for fatigue detection.

According to one embodiment, in step d), a time signal is compressed sensed.

During compressed sensing, adaptive and pseudorandom subsampling can be advantageously used.

According to a further embodiment, in step d), a position of the object in the interior and/or in the exterior is derived as its state.

In the present case, the “position” is to be understood as the arrangement of the object in space. On the one hand, it can be derived whether the object is arranged in the interior and/or in the exterior, and on the other hand, where the object is arranged in the interior and/or in the exterior.

According to a further embodiment, in step d), vital functions of the object, in particular its respiratory rate and/or its heart rate, are derived as its state.

As previously mentioned, this advantageously enables fatigue detection. For example, it can be assumed that fatigue of the vehicle driver has occurred when the respiratory rate and/or the heart rate decreases. Vital functions may also include body temperature or blood pressure. Furthermore, vital functions of vehicle occupants sitting in the rear seats of the motor vehicle can also be monitored, for example.

According to another embodiment, in step c), the reflected electromagnetic radiation is received by a radiation receiver in the form of a phased array antenna or a MIMO antenna.

In principle, any antenna can be used as a radiation receiver. “MIMO” stands for “Multiple-Input Multiple-Output” and refers to a method or transmission system for using multiple transmitting and receiving antennas for wireless communication. A “phased array antenna” is a phase-controlled array antenna with strong directivity that achieves bundling of the radiated energy by arranging and interconnecting individual radiators. If the individual radiators can be driven differently, the antenna pattern of the antenna can be swiveled electronically. This is referred to as electronic beam panning.

According to a further embodiment, in step d), electronic panning of a beam of the radiation receiver is performed, wherein the beam is directed at least temporarily to the object.

In this case, the radiation receiver is a phased array antenna whose individual radiators can be driven differently.

According to a further embodiment, in step d), the beam is directed successively onto objects that differ from one another.

This makes it possible to monitor several objects simultaneously with only one radiation receiver. The panning of the beam is preferably random or pseudo-random.

According to a further embodiment, in step c), heating wires of a rear window heater of the motor vehicle are used as radiation receiver.

For this purpose, the heating wires are placed at suitable distances from each other. The heating wires can thus form a MIMO antenna in the frequency range of interest. At the same time, however, the heating wires also serve to heat the rear window. The heating wires thus have a dual function. Furthermore, the installation of an additional radiation receiver can be advantageously dispensed with. The heating wires can also serve as a radiation source at the same time.

According to a further embodiment, in step a), emitting the electromagnetic radiation is performed by means of a radiation source which is intended for a primary function which differs from the method.

This means that the radiation source is not exclusively intended for the method, but initially has a primary function, for example as a WLAN hotspot. Only as a secondary function, the electromagnetic radiation is emitted by the radiation source used for the method. In this case, the radiation source is preferably a component of the motor vehicle that primarily has a function other than emitting the electromagnetic radiation for monitoring the interior and the exterior. Only as an additional function or secondary function, the monitoring of the interior and the exterior is performed by means of the electromagnetic radiation. Multiple radiation sources may be provided. By preferably not requiring an additional radiation source, cost and complexity can be reduced. Further, by not requiring an additional radiation source, customer acceptance is expected to be higher.

According to a further embodiment, in step a), a WLAN hotspot of the motor vehicle and/or a UWB antenna of a locking system of the motor vehicle is used as the radiation source.

For example, the locking system may have a plurality of UWB antennas, preferably mounted so that they can both detect the approach of a key to the motor vehicle in the exterior and radiate into the interior so that it can be monitored using the method. In particular, this means that the radiation source is preferably not a component that is used exclusively for the method. As mentioned before, the radiation source is only used as a secondary function for the method.

Furthermore, a monitoring device for monitoring an interior and/or an exterior of a motor vehicle is provided. The monitoring device comprises a radiation source for emitting electromagnetic radiation into the interior and/or into the exterior, a radiation receiver for receiving electromagnetic radiation reflected from an object arranged in the interior and/or the exterior, and an evaluation apparatus for compressed sensing of a signal of the reflected electromagnetic radiation to derive therefrom an information about a state of the object.

The monitoring device is integrated into the motor vehicle. In this case, the monitoring device uses as many as possible of the components already required for operation of the motor vehicle, such as a radiation source in the form of a WLAN hotspot. The evaluation apparatus can be part of a control unit of the motor vehicle. In particular, the evaluation apparatus may be a computer program stored in the control unit. The explanations concerning the method are to be applied accordingly to the monitoring device and vice versa.

According to one embodiment, the radiation receiver is a phased array antenna or a MIMO antenna.

For example, the motor vehicle can comprise two MIMO antennas as radiation sources, which are each placed above seats, in particular a driver's seat and a passenger's seat. These radiation sources can comprise as their primary function, for example, the provision of a WLAN hotspot. Furthermore, a radiation receiver designed as a phased array antenna can additionally be placed above and between the seats in this case.

According to another embodiment, the radiation source fulfills a primary function which is independent of the monitoring device, wherein the radiation source is part of the monitoring device as a secondary function which is different from the primary function.

In other words, the radiation source is thus preferably not a component that has to be installed separately to form the monitoring device. As mentioned before, the primary function can be, for example, the provision of a WLAN hotspot. As a secondary function, this WLAN hotspot emits the electromagnetic radiation for monitoring the interior and/or the exterior.

According to another embodiment, the radiation source is a WLAN hotspot of the motor vehicle and/or a UWB antenna of a locking system of the motor vehicle.

The locking system is in particular a so-called “Keyless Go” system. For example, the locking system can comprise several UWB antennas, which are preferably mounted in such a way that they can both detect the approach of a key to the motor vehicle in the exterior and radiate into the interior in order to be able to monitor it.

According to another embodiment, the radiation receiver is formed by heating wires of a rear window heater of the motor vehicle.

In this case, the radiation receiver is also effective in particular in the direction of the exterior, so that so-called dooring accidents with cyclists can be reliably prevented. Here, the heating wires are placed at suitable distances from each other in such a way that, for example, a MIMO antenna can be implemented in the frequency range of interest. At the same time, the heating wires act as a rear window heater for a rear window of the motor vehicle. Furthermore, the heating wires can also function as a radiation source.

In the present context, “one” is not necessarily to be understood as being limited to exactly one element. Rather, several elements, such as two, three or more, may also be provided. Also, any other counting word used herein is not to be understood as limiting to exactly the number of elements mentioned. Rather, numerical deviations upwards and downwards are possible, unless otherwise specified.

Further possible implementations of the method and/or the monitoring device also include combinations of features or embodiments described previously or below with respect to the embodiment examples that are not explicitly mentioned. In this context, the person skilled in the art will also add individual aspects as improvements or additions to the respective basic form of the method and/or the monitoring device.

Further advantageous embodiments and aspects of the method and/or the monitoring device are the subject of the subclaims as well as the embodiments of the method and/or the monitoring device described below. In the following, the method and/or the monitoring device are explained in more detail on the basis of preferred embodiments with reference to the accompanying figures.

### BRIEF DESCRIPTION OF THE DRAWINGS

FIG. 1 shows a schematic top view of an embodiment of a motor vehicle; and

FIG. 2 shows a schematic block diagram of an embodiment of a method for monitoring an interior and/or an exterior of the motor vehicle according to FIG. 1.

### DETAILED DESCRIPTION

In the figures, identical or functionally identical elements have been given the same reference signs unless otherwise indicated.

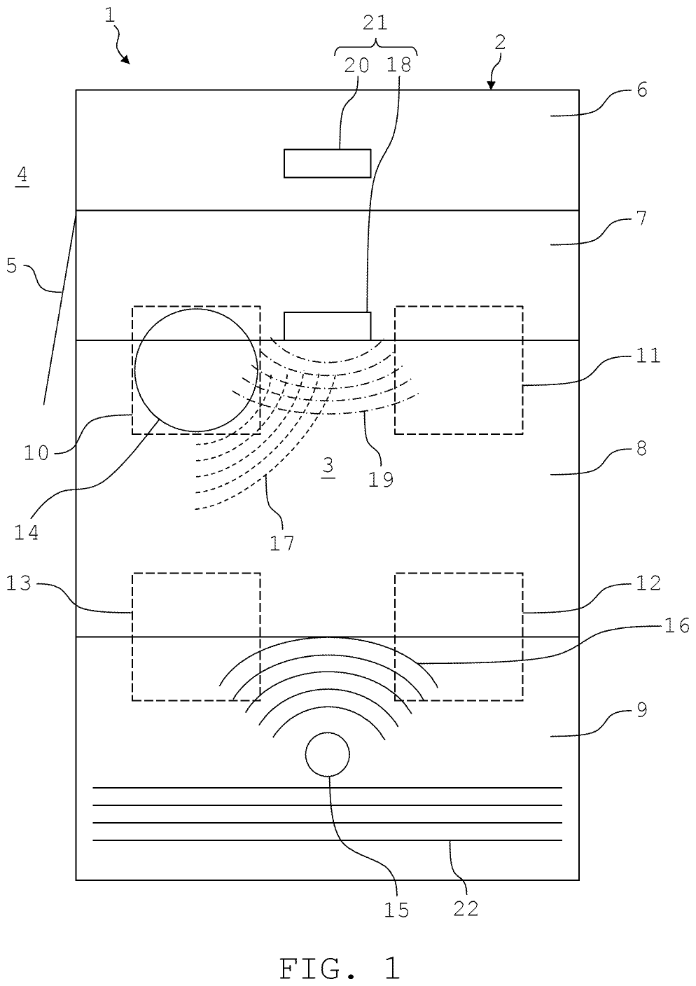

FIG. 1 shows a highly simplified schematic top view of a motor vehicle 1. The motor vehicle 1 may be a passenger car, truck or the like. The motor vehicle 1 comprises a body 2 which delimits an interior 3 of the motor vehicle 1. Outside the body 2 an exterior 4 of the motor vehicle 1 is provided. The body 2 delimits the interior 3 from the exterior 4. The interior 3 is accessible from the exterior 4 via doors 5. For example, two or four doors 5 may be provided.

The body 2 comprises an engine hood 6, a front screen 7, a roof 8 and a rear window 9. Furthermore, a tailgate may also be provided. Seats 10 to 13 are arranged in the interior 3 on which occupants can sit. The seat 10 is a driver's seat. Seats 11 to 13 are passenger seats. The number of seats 10 to 13 is arbitrary. Seats 10, 11 are front seats. Seats 12, 13 are rear seats or together form a rear bench seat. The number of seats 10 to 13 is basically arbitrary.

For example, an object 14 is placed on the seat 10. An object 14 may be placed on each seat 10 to 13. The object 14 placed on the seat 10 is a vehicle occupant, in particular a vehicle driver or vehicle operator, or may be referred to as such. That is, the terms “object” and “vehicle occupant” may be interchanged as desired. However, the object 14 may also be an animal or an inanimate object such as a bag, smartphone or the like.

The motor vehicle 1 further comprises a radiation source 15 suitable for emitting electromagnetic radiation 16 into the interior 3 and at least partially into the exterior 4. The electromagnetic radiation 16 can thereby be emitted directionally or non-directionally. By “directional” it is to be understood that the radiation source 15 emits the electromagnetic radiation 16 substantially in one direction, for example in a lobe shape. By “non-directional” it is to be understood that the radiation source 15 emits the electromagnetic radiation 16 in all directions, that is, spherically. The electromagnetic radiation 16 can be used to monitor the interior 3 and at least partially the exterior 4.

The radiation source 15 is a component of the motor vehicle 1 that has a primary function other than emitting electromagnetic radiation 16 for monitoring the interior 3 and the exterior 4. That is, the radiation source 15 has a primary function. For example, the primary function of the radiation source 15 may be to provide a WLAN hotspot. Only as an additional function or secondary function, monitoring of the interior 3 and the exterior 4 is performed by means of the electromagnetic radiation 16. Several radiation sources 15 may be provided. However, only one radiation source 15 will be discussed in the following.

The radiation source 15 is thus present anyway, independently of the secondary function, to perform its primary function. This means that for monitoring the interior 3 and the exterior 4, i.e., for the secondary function, basically no additional radiation source is required apart from the radiation source 15 already installed in or on the motor vehicle 1. This reduces costs and reduces complexity. Furthermore, by dispensing with an additional radiation source, greater customer acceptance can be expected.

However, for fulfilling both the primary function and the secondary function, the radiation source 15 can be selected and/or placed in the interior 3 in such a way that it is not only suitable for fulfilling the primary function, but also the secondary function at the same time. For example, it may be sufficient for the pure fulfillment of the primary function that the radiation source 15 has a low transmission power. Now, in order to be able to fulfill both the primary function and the secondary function, a radiation source 15 with a higher transmission power may be required compared to the pure fulfillment of the primary function. In other words, the radiation source 15 can be suitably selected or dimensioned for the secondary function, namely monitoring the interior 3 and the exterior 4, and/or placed in an installation location suitable for fulfilling the secondary function.

The radiation source 15 is in particular an antenna. The radiation source 15 is, for example, a WiFi hotspot or a WLAN hotspot for implementing a wireless local area network (WLAN) or an ultra-wideband antenna (UWB). The radiation source 15 may be a multiple-input multiple-output (MIMO) antenna. In several areas of wireless transmission in communications technology, MIMO refers to a method or transmission system for using multiple transmit and receive antennas for wireless communication. Any number of different radiation sources 15 performing different primary functions may be provided. In the case where different radiation sources 15 are provided, although they perform different primary functions, they may jointly perform the secondary function.

The radiation source 15 can also be a radar antenna or an antenna, in particular a UWB antenna, of a keyless entry system (Keyless Go). In particular, the radiation source 15 emits electromagnetic radiation 16 in the ISM band (Industrial, Scientific and Medical Band, ISM) in the frequency range from 5725 MHz to 5875 MHz. The radiation source 15 is particularly suitable for emitting electromagnetic radiation 16 of any wavelength. The electromagnetic radiation 16 is at least partially reflected and at least partially absorbed by the object 14. Reflected electromagnetic radiation is provided with the reference sign 17 in FIG. 1.

A radiation receiver 18 is provided for receiving the reflected electromagnetic radiation 17. A plurality of radiation receivers 18 may be provided. However, only one radiation receiver 18 will be discussed in the following. The radiation receiver 18 may be an antenna arranged in a headliner area, that is, on the roof 8, or on the front screen 7, for example in the area of a sunshade strip between the seats 10, 11.

The radiation receiver 18 may be mounted at any location in the interior 3 and/or the exterior 4. The radiation receiver 18 may be an existing component of the motor vehicle 1. That is, like the radiation source 15, the radiation receiver 18 may also have a primary function and a secondary function independent of the primary function. However, the radiation receiver 18 may also be a component that is additionally provided on or in the motor vehicle 1.

The radiation receiver 18 is a phase-controlled array antenna, in particular a so-called phased array antenna, or a MIMO antenna. In principle, any type of antenna can be used as a radiation receiver 18. In particular, the radiation receiver 18 is sufficiently broadband so that it can cover the WiFi 5 GHz+ channels approved in Europe and the USA as well as the ISM band in the range from 5725 MHz to 5875 MHz. Further, the radiation receiver 18 may have directionality.

For example, the motor vehicle 1 may have two MIMO antennas as radiation sources 15, each of which is placed above the seats 10, 11. These radiation sources 15 may have as their primary function the provision of a WLAN hotspot. Furthermore, a radiation receiver 18 designed as a phased array antenna can in this case be placed above and between the seats 10, 11.

In the case that the radiation receiver 18 is a phased array antenna, this has a strong directivity which achieves a bundling of the radiation energy by the arrangement and interconnection of individual radiators. Since the individual radiators can be driven differently, the antenna pattern of the phased array antenna is electronically slewable. The radiation receiver 18 can thus perform electronic panning of its beam 19 so that signals from different objects 14 can be distinguished from one another. For example, the presence of an object 14 can be detected by a change in channel response to WiFi pilot signals. Vital functions, such as heartbeat and/or respiration, can be detected via a radar signal in the ISM band.

The motor vehicle 1 further comprises an evaluation apparatus 20. The evaluation apparatus 20 may be part of a vehicle control system of the motor vehicle 1. For example, the evaluation apparatus 20 may be a computer program stored in the vehicle control system. The evaluation apparatus 20 is suitable for evaluating a signal, in particular a time signal, of the reflected electromagnetic radiation 17 by means of compressed sensing. That is, the evaluation apparatus 20 can employ adaptive and pseudorandom subsampling. The radiation receiver 18 and the evaluation apparatus 20 thereby form a monitoring device 21 of the motor vehicle 1.

Compressed sensing is a method for the acquisition and reconstruction of sparse signals or information sources. These can be compressed without significant loss of information due to their redundancy. This is used efficiently when sampling the signals to significantly reduce the sampling rate compared to conventional methods. Even smallest amplitudes and weak signals can be evaluated. This significantly reduces the amount of data generated. A time division multiplexing of the electronically swept beam 19 of the radiation receiver 18 is applied pseudo-randomly instead of regularly to the multiple objects 14 to design the signal acquisition to the signal reconstruction scheme in the sparse transform domain.

The combination of a WLAN hotspot and radar also make it possible to reliably detect objects 14 in the form of smartphones in the interior 3. A calibration of the monitoring device 21 can be performed on a channel response of the empty motor vehicle 1 or on the seat position with the object 14 or the like. In other words, a comparison is made between empty and non-empty.

A plurality of UWB antennas of a keyless unlocking system as previously mentioned can be mounted as radiation sources 15 in such a way that they can both detect the approach of a key to the motor vehicle 1 in the exterior 4 and provide a detection area in the interior 3. That is, the UWB antennas also emit electromagnetic radiation 16 into the interior 3 for monitoring thereof. A control logic of the UWB system can be used in the absence of the key or while driving to notice the presence of objects 14. By means of Doppler measurement techniques, this hardware can also be used to detect vital signs. Here, the relatively low frequency of 6.5 GHz of the UWB system can be particularly advantageous, as this wavelength penetrates further into the body than, for example, 24 GHz or 60 GHz+.

Non-body internal movements, such as vibrations or acoustics, are fused with the relevant body internal acoustics or vibration. This can be done by considering data from an inertial measurement unit (IMU), which can be decomposed into its individual components. An inertial measurement unit is a spatial combination of several initial sensors, such as accelerometers or angular rate sensors. That is, these data are subtracted from a signal acquired with a radar or supplied as input to an artificial intelligence with a neural network. This results in a decoupling of the various vibration sources. This in turn leads to a reduction in the false position (FP) rate and to an improvement in accuracy.

By means of a suitable design of heating wires 22 provided in or on the rear window 9, the radiation source 15 and/or the radiation receiver 18 can be realized by means of an already existing component, namely the heating wires 22. For example, the heating wires 22 can transmit and receive in the ISM band at 5.8 GHz. At the same time, the heating wires 22 can still perform the function of heating the rear window 9. For this purpose, the heating wires 22 are placed at suitable distances from each other in such a way that, for example, a MIMO antenna can be implemented in the frequency range of interest.

Furthermore, the radiation source 15 formed by the heating wires 22 or the radiation receiver 18 can also be detuned so that WiFi frequencies in the 5 GHz spectrum can be transmitted and received. This sensor system provided on the rear window 9 also acts in the direction of the exterior 4, so that so-called dooring accidents with cyclists can be prevented.

The monitoring of a child seat, for example regarding temperature and humidity, can be realized as a solution integrated into the motor vehicle 1. The sensors required for this do not need a power supply in the form of a plug or a battery. The power supply for the sensor system can be provided by means of the radio frequency field of the radiation source 15 active in the interior 3. The readout of the measured values can be carried out, for example, via a Bluetooth/WiFi functionality of the motor vehicle 1. Deviating values can be displayed.

Multiple use of existing hardware in the motor vehicle 1, such as WLAN or UWB, is therefore possible. Efficient multiplexing of a radar signal is possible. Determining the position of a cell phone in the interior 3 is possible. A single antenna array can be used collaboratively. Calibration of the monitoring device 21 is performed on the empty interior 3. Compressed sensing is used at least for signal evaluation of the time series data of pulse and respiration. By using substantially existing components to implement the monitoring device 21, it is easy for a user to accept the monitoring device 21 as opposed to using additional components.

Costs can be saved by avoiding redundancy in electrical systems. Fewer connectors are required, and a simpler wiring harness is therefore possible. The monitoring of seats 12, 13 in terms of child detection and passenger presence according to New Car Assessment Program (NCAP) and legislation can be fulfilled without installing additional antennas or cameras. In addition, this fulfills the function of monitoring overtaking bicycle traffic.

Children or animals left on the seats 12, 13 can be easily and reliably detected. Communication of the motor vehicle 1 with the outside infrastructure is possible and vulnerable road users, such as cyclists and motorcyclists, can be detected when approaching from behind so that an opening of the door 5 resulting in a collision can be prevented.

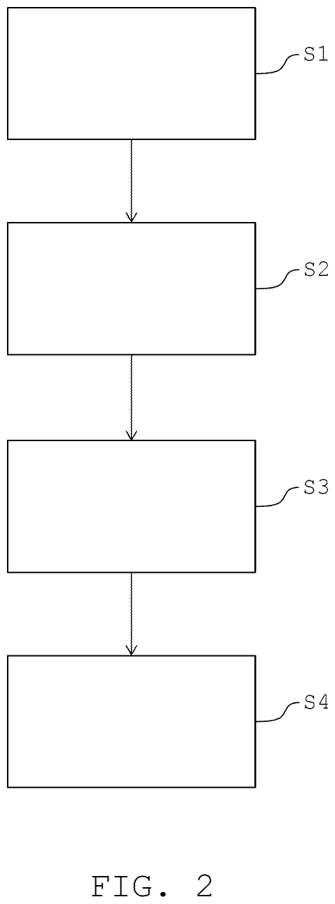

FIG. 2 shows a schematic block diagram of an embodiment of a method for monitoring the interior 3 and/or the exterior 4 by means of the monitoring device 21 and a method for operating the monitoring device 21, respectively. Remarks concerning the monitoring device 21 are to be applied accordingly to the method and vice versa.

In the method, in a step S1, the electromagnetic radiation 16 is radiated into the interior 3 and/or into the exterior 4. The electromagnetic radiation 16 can be emitted from any radiation source 15 that is present anyway, for example in the form of a WLAN hotspot. This means that the radiation source 15 does not have to be specially installed for the method.

In a step S2, the electromagnetic radiation 16 is at least partially reflected by the object 14 arranged in the interior 3 and/or in the exterior 4. At least partially, the object 14 also absorbs the electromagnetic radiation 16. The electromagnetic radiation 16 can also be reflected by several objects 14.

In a step S3, the electromagnetic radiation 17 reflected by the object 14 is received. The radiation receiver 18, preferably in the form of a MIMO antenna or a phased array antenna, is provided for this purpose.

In a step S4, a signal, in particular a time signal, of the reflected electromagnetic radiation 17 is sensed in a compressed manner to derive information about a state of the object 14. By using compressed sensing, it is possible to keep the amount of data generated small. Furthermore, weak signals and small amplitudes can be evaluated. Steps S1 to S4 can be performed simultaneously or sequentially in time.

Although the present invention has been described with reference to examples of embodiments, it can be modified in a variety of ways.

### LIST OF REFERENCE CHARACTERS

1 Motor vehicle

2 Body

3 Interior

4 Exterior

5 Door

6 Engine hood

7 Front screen

8 Roof

9 Rear window

10 Seat

11 Seat

12 Seat

13 Seat

14 Object

15 Radiation source

16 Radiation

17 Radiation

18 Radiation receiver

19 Beam

20 Evaluation apparatus

21 Monitoring device

22 Heating wire

S1 Step

S2 Step

S3 Step

S4 Step

1. A method for monitoring an interior and/or an exterior of a motor vehicle, comprising the following steps:
a) Emitting electromagnetic radiation into the interior and/or into the exterior,
b) Reflecting the electromagnetic radiation at an object arranged in the interior and/or in the exterior,
c) receiving electromagnetic radiation reflected from the object, and
d) compressed sensing a signal of the reflected electromagnetic radiation to derive therefrom an information about a state of the object.

2. The method according to claim 1,
characterized in that
in step d), a time signal is compressed sensed.

3. The method according to claim 1,
characterized in that
in step d), a position of the object in the interior and/or in the exterior is derived as its state.

4. The method according to claim 1,
characterized in that
in step d), vital functions of the object, in particular its respiratory rate and/or its heart rate, are derived as its state.

5. The method according to one of claims,
characterized in that
in step c), the reflected electromagnetic radiation is received by a radiation receiver in the form of
a phased array antenna or a MIMO antenna.

6. The method according to claim 5,
characterized in that
in step d), electronic panning of a beam of the radiation receiver is performed, and in that the beam (19) is directed at least temporarily onto the object.

7. The method according to claim 6,
characterized in that
in step d), the beam is directed successively onto objects which differ from one another.

8. The method according to claim 5 ,
characterized in that
in step c), heating wires of a rear window heater of the motor vehicle are used as radiation receiver.

9. The method according to claim 1,
characterized in that
in step a), emitting the electromagnetic radiation is performed by means of a radiation source which is intended for a primary function which differs from the method.

10. The method according to claim 9,
characterized in that,
in step a), a WLAN hotspot of the motor vehicle and/or a UWB antenna of a locking system of the motor vehicle is used as the radiation source.

11. A monitoring device for monitoring an interior and/or an exterior of a motor vehicle (1), comprising
a radiation source for emitting electromagnetic radiation into the interior and/or into the exterior,
a radiation receiver for receiving electromagnetic radiation reflected from an object arranged in the interior and/or in the exterior, and
an evaluation apparatus for compressed sensing of a signal of the reflected electromagnetic radiation to derive therefrom an information about a state of the object.

12. The monitoring device according to claim 11,
characterized in that
the radiation receiver is a phased array antenna or a MIMO antenna.

13. The monitoring device according to claim 11,
characterized in that
the radiation source fulfills a primary function which is independent of the monitoring device, and in that the radiation source is part of the monitoring device as a secondary function which is different from the primary function.

14. The monitoring device according to claim 12,
characterized in that
the radiation source is a WLAN hotspot of the motor vehicle and/or a UWB antenna of a locking system of the motor vehicle.

15. The monitoring device according to claim 11,
characterized in that
the radiation receiver is formed by heating wires of a rear window heater of the motor vehicle.
